(19) United States
(12) Patent Application Publication
(10) Pub. No.: US 2025/0077527 A1
(43) Pub. Date: Mar. 6, 2025

(54) VARIABLE PRECISION IN VECTORIZATION

(71) Applicant: Intel Corporation, Santa Clara, CA (US)

(72) Inventor: Robert Vaughn, Portland, OR (US)

(21) Appl. No.: 18/930,440

(22) Filed: Oct. 29, 2024

(51) Int. Cl. G06F 16/2457; G06F 16/22

(52) U.S. Cl. CPC G06F 16/24573; G06F 16/2237

(57) ABSTRACT

Systems, apparatuses and methods may provide for technology that identifies a first keyword and a second keyword in a plurality of keywords, determines that a first relevance associated with the first keyword is greater than a second relevance associated with the second keyword, vectorizes the first keyword to a first level of precision, vectorizes the second keyword to a second level of precision, wherein the first level of precision is greater than the second level of precision, and stores the vectorized first keyword and the vectorized second keyword to a retrieval-augmented generation (RAG) vector database.

### BACKGROUND

Retrieval-augmented generation (RAG) is an artificial intelligence (AI) model retraining alternative that can create a domain-specific large language model (LLM) by augmenting open-source pre-trained models with both proprietary and open data. When a RAG system is created, corpus data (a “corpus”) is vectorized and stored in a database. Vectorization typically produces floating point values that are of uniform precision for a variety of reasons (e.g., easier to implement, easier to optimize compute accelerators, etc.). Uniform precision also presents an inefficiency, however, in two respects: 1) less important words (e.g., “tokens”) such as “the”, and “and” have the same precision as more important words; and 2) the size of the vector database becomes very large.

### BRIEF DESCRIPTION OF THE DRAWINGS

The various advantages of the embodiments will become apparent to one skilled in the art by reading the following specification and appended claims, and by referencing the following drawings, in which:

FIG. 1 is a comparative listing of an example of a conventional code snippet and an enhanced code snippet according to an embodiment;

FIG. 2 is a polar plot of an example of variable precision vector data according to an embodiment;

FIG. 3 is a flowchart of an example of a method of building a retrieval-augmented generation (RAG) vector database according to an embodiment;

FIG. 4 is a flowchart of an example of a method of handling user queries according to an embodiment;

FIG. 5 is a block diagram of an example of a performance-enhanced computing system according to an embodiment;

FIG. 6 is an illustration of an example of a semiconductor package apparatus according to an embodiment;

FIG. 7 is a block diagram of an example of a processor according to an embodiment; and

FIG. 8 is a block diagram of an example of a multi-processor based computing system according to an embodiment.

### DETAILED DESCRIPTION

As already noted, vectorizing a corpus of a retrieval-augmented generation (RAG) system into uniform precision presents an inefficiency, in that: 1) less important words (e.g., “tokens”) such as “the”, and “and” have the same precision as more important words; and 2) the size of the vector database becomes very large. Moreover, quantization solves the problem only partially (e.g., quantization may only reduce the precision of the entire vector database).

The technology described herein introduces a dual stage model where higher importance keywords are identified and then vectorized to higher precision versus lower importance keywords. The technology described herein also introduces embedding vectors into documents to facilitate near real-time integration into local RAG systems. Accordingly, embodiments may vary precision based on term importance (e.g., rather than static precision and/or uniform quantization), provide for context-aware vectorization (e.g., rather than traditional methods that lack the dynamic adjustment of precision according to keyword context), enable practical embedding of vectors (e.g., rather than conventional RAG that does not practically extend to document embedding), provide for storage optimization (e.g., rather than standard approaches that do not reduce vector database size by precision variation) and/or enable dynamic similarity calculation (e.g., matching query precision to document vectors dynamically).

As will be discussed in greater detail, when building a RAG system, the technology described herein can identify keywords of higher relevance or importance, vectorize higher importance keywords to greater precision, and store vectors in a modified vector database. Additionally, when operating a RAG system, the technology described herein can detect the arrival of a user query, match query keywords to corpus vector keywords, vectorize the query string variably, and conduct a vector search. In one example, vector searching at the hardware layer involves calculating relevant vectors.

The technology described herein achieves a 25× improvement in vector storage over optimized standard vectorization without loss of performance/accuracy. Benefits of the technology described herein include improved efficiency (e.g., reduced vector database size for faster retrieval), precision (e.g., higher precision assigned to important keywords, enhancing relevance), balance (e.g., optimized performance and accuracy by varying precision), storage (e.g., lower storage requirements through a reduction of precision in less important vectors), relevance (e.g., improved document retrieval relevance by emphasizing key terms), and portability (e.g., vectors can be embedded in documents and indexed by search engines, making it more practical for vector sets to become embedded in client-side documents).

Previously, there may have been several barriers to practical adoption of variable precision in vectorization. First, uniform precision of calculations on floating point (FP) numbers (e.g., cosign similarity) works very well with existing graphics processing unit (GPU) hardware and software (e.g., CUDA). Second, an additional operation is involved in determining what values should have variable precision. Third, vector search involves an additional operation. Fourth, the data structure of vector databases is adapted.

It has been determined, however, that the size of the vector database can be reduced under the technology described herein. As a shift takes place to local LLMs and vectors embedded in documents, this size reduction is significant. Additionally, the efficiency and accuracy of vectors based on keyword relevance has largely been ignored because performance can be improved by adding more parameters. But, again, when shifting to local LLMs (e.g., INTEL AI PC) then this efficiency and accuracy becomes an important consideration.

### BACKGROUND

If the DistilBert transformer model is used to vectorize the sentence “The weather is nice today.” The vectors would appear as follows:
Token: the
Vector: [‘−0.11691234’, ‘−0.51191902’, ‘−0.47443977’, ‘0.15859115’, ‘0.45076767’, ‘−0.02895808’, ‘−0.16985145’, ‘1.33891368’, ‘−0.15777914’, ‘−0.74268699’, ‘0.07677958’, ‘−0.41876084’, ‘−0.35312998’, ‘0.65221089’, ‘−0.79573739’, ‘0.67620075’, ‘0.60528213’, ‘0.06027437’, ‘−0.01193807’, ‘0.29516006’, . . .
Token: weather
Vector: [‘−0.11492143’, ‘−0.02140375’, ‘−0.09779197’, ‘−0.06286228’, ‘0.82680070’, ‘−0.01936082’, ‘0.02517128’, ‘1.72691429’, ‘−0.58424443’, ‘−0.15583989’, ‘0.18211974’, ‘−0.68537706’, ‘−0.08372908’, ‘0.45082143’, ‘−0.74896425’, ‘0.97105622’, ‘−0.10397870’, ‘0.07825424’, ‘0.36716208’, ‘0.36405644’, . . .

In the above, the words “the” and “weather” have the same floating point precision even though the relevance of the keywords is different.

### Implementation Details

The technology described herein improves retrieval efficiency and accuracy by dynamically adjusting the precision of vector representations during vectorization based on keyword importance. The natural language processing (NLP) and information retrieval approach TF-IDF (Term Frequency-Inverse Document, although other approaches such as 25 iteration Best Match/BM25 may be used), may identify key terms within documents and assign higher precision to their corresponding vectors, ensuring more detailed and accurate representations. Less important terms are assigned lower precision, reducing the overall size of the vector database. This approach balances performance and relevance, enhancing retrieval speed while emphasizing critical information, making it more efficient than conventional RAG solutions that use uniform precision.

The DistilBERT model and tokenizer from the transformers library can generate document embeddings, and the TfidfVectorizer from scikit-learn can identify keywords within the documents. In testing other models, tokenizers, etc., similar performance gains were observed.

Floating point values are not practical to lossless compress. The technology described herein selectively reduces precision with no loss in performance.

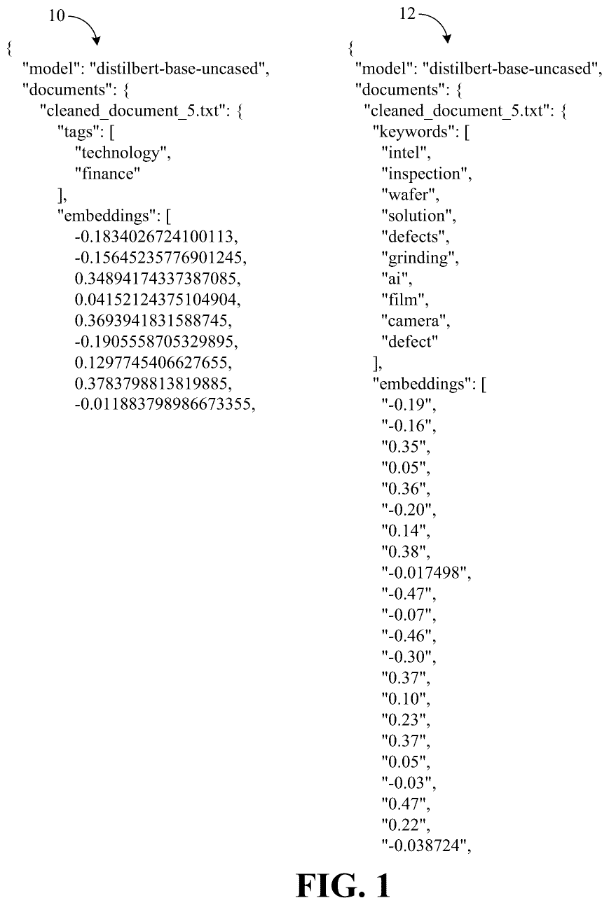

FIG. 1 shows a conventional code snippet 10 that performs standard vectorization (non-serialized for readability) and an enhanced code snippet 12 that performs dual stage or variable precision vectorization (also non-serialized for readability). In the snippets 10, 12, there is not a linear relationship between embeddings and keywords. Keywords stored in the vector are for subsequent query optimization. The reduced precision in the enhanced code snippet 12 is not quantization. Rather, the technology described herein adjusts precision based on keyword importance in a dynamic manner, whereas quantization uniformly reduces precision across all vector components.

### Two Operation Vectorization:

1. The vectorization process takes place in two operations including the keyword and key-phrase identification and variable precision weighting.

2. The optimized size of the vector data set provides for embedding of discrete vectors within their respective document as meta data enables for two stages (e.g., locations) of RAG: 1) centralized conventional RAG and 2) vectors stored in documents (e.g., making the vectors portable).

There are two key performance metrics involved with technology described herein. Accuracy—embodiments achieve the same or better performance when compared to fixed precision vectorization. Vector database size—embodiments generate a smaller vector database for the same corpus.

### Performance (Accuracy)

Presenting the same question, “Explain data center efficiency”, to a Model A of a RAG system using standard fixed precision and a Model B of a RAG system using variable precision (e.g., using public whitepapers as the corpus) and the same embedding model, “DistilBert”, results as follows:
Model A (fixed precision)
root@localhost:/project_dualrag #python3 query vector_database.py

### Top Matching Documents:

cleaned_document_1.txt: 0.6422798921985478
cleaned_document_3.txt: 0.6388351276697886
cleaned_document_2.txt: 0.632192989506304
cleaned_document_4.txt: 0.5944336626561824
cleaned_document_5.txt: 0.5690588677849877
Model B (variable precision)
root@localhost:/project varprec #python3 query vector_database.py

### Top Matching Documents:

cleaned_document_1.txt: 0.6428824607232778
cleaned_document_3.txt: 0.6406441536721341
cleaned_document_2.txt: 0.6336038827826889
cleaned_document_4.txt: 0.5926776283581829
cleaned_document_5.txt: 0.565363070609663

Results: The similarity values were close but slightly different. The documents were sorted the same. Additionally, the variable precision model was as accurate as the fixed precision model.

### Performance (Size)

TABLE I

| | Size of Vector DB | |
|---|---|---|
| Metric | (as VARCHAR) | |
| non-optimized standard vectorization | 141 | KB |
| optimized standard vectorization | 77 | KB |
| Variable precision vectorization | 3 | KB |

Table I demonstrates that the size of the vector database (e.g., actual vectorizations) is substantially reduced. Indeed, a 25× improvement can be achieved over optimized standard vectorization.

There are differences between storing vectors as a string (e.g., VARCHAR), FLOAT (floating point), DOUBLE (double precision floating point), etc. Additionally, the technology described herein extends to other “stages” such as, for example, INTEL AI PC.

Performance is also a measurement of accuracy and testing has demonstrated that accuracy remains consistent with conventional solutions.

Vectorization typically produces floating point values such as the following:
−0.2471979856491089, 0.14869987964630127, 0.35144293308258057

The precision of signed DOUBLE has sixteen or seventeen decimal places of precision.

To optimize storage, the only practical option may be to uniformly reduce precision via quantization. Such an approach, however, is typically done without consideration of where greater precision is required.

An analysis of a large document that was vectorized provided the following results.
Count of values: 768 (e.g., how many vectors were generated).
VARCHAR storage (standard FP dataset): 8.63 KB.
VARCHAR storage (variable precision dataset): 4.24 KB.
FLOAT storage: 3.00 KB.
DOUBLE storage: 6.00 KB.
Custom binary storage: 3.75 KB.

In the above, “Count of values” refers to the count of vectors. Although FLOAT may appear to be the best option, FLOAT is limited to ˜7 decimal places. Therefore, precision is lost.

The technology described herein proposes variable precision vectors. More particularly, the following examples provide a contrasting perspective.

### Standard Vectors

−0.2471979856491089, 0.14869987964630127, 0.35144293308258057

### Variable Precision Vectors

−0.26, 0.148578, 0.36

The length of the decimal points in the above examples is literally reduced in a contextually relevant way. Moreover, the three values for the variable precision vectors have had the benefit of precision being increased or decreased based on the relative importance of the vector.

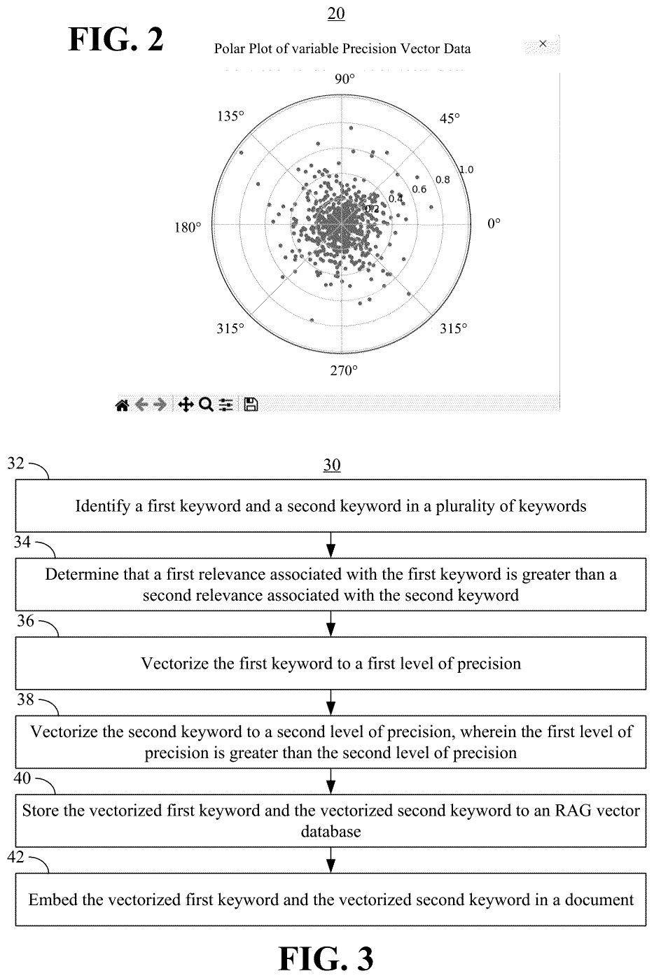

FIG. 2 shows a polar plot 20 that further demonstrates the benefit of variable precision vectors. If standard vectorization were used, then the plot 20 would “run the circumference” showing uniform vector sizes and storage. With variable precision vector data, every dot (e.g., a vector) that appears inside the circumference represents a benefit in loss-less data compression and an increase in performance. If all the data (e.g., vectors) is held on centralized vector databases, then purchasing more storage might be an option. Smaller data is faster, however, on indexing (e.g., vector, SQL). Additionally, variable precision vectorization makes it much more practical to store vectors in client-side documents and to make the vectors portable via email, website download, etc. Accordingly, VARCHAR references are relevant.

### Custom Binary Storage

The technology described herein proposes a custom binary storage solution that is designed to store floating-point numbers with variable precision efficiently. The solution involves encoding each value with the exact number of significant decimal places involved, minimizing storage space while preserving precision.

### Encoding Process

1) Precision Byte: For each number, store the precision (e.g., number of decimal places) in a single byte.

2) Scaled Integer Value: Convert the floating-point number to an integer by scaling it based on its precision. Store this scaled integer in the minimum number of bytes required.

### Operations

1) Determine the precision of the floating-point number (e.g., the number of decimal places).
2) Scale the number by multiplying the number by 10^{precision}
3) Store the precision as a single byte.
4) Store the scaled integer using the minimum number of bytes needed.

### Example

For the number −0.2471979856491089:
1) Precision: 16 decimal places.
2) Scaled Value: −0.2471979856491089×10¹⁶=−24719798564910890
3) Store Precision: 1 byte.
4) Store Scaled Value: 8 bytes (since −24719798564910890 fits in 8 bytes).
   Storage Comparison with FLOAT and DOUBLE

### Standard Vector Values

The standard vector values used for comparison:
−0.2471979856491089
0.14869987964630127
0.35144293308258057

### Custom Binary Vector Values

The custom binary vector values used for comparison:
−0.26
0.148578
0.36
FLOAT Storage
FLOAT (Single-Precision 32-bit): Approximately 7 decimal digits of precision.

Each value is stored in 4 bytes: Precision Loss with FLOAT—Taking the value −0.2471979856491089 as an example:
Original Value: −0.2471979856491089
Stored as FLOAT: −0.2471979 (approximate, as FLOAT only provides ˜7 decimal digits of precision)
DOUBLE Storage
DOUBLE (Double-Precision 64-bit): Approximately 15-16 decimal digits of precision.

Each value is stored in 8 bytes: Precision Retention with DOUBLE—Taking the same value −0.2471979856491089:
Original Value: −0.2471979856491089
Stored as DOUBLE: −0.2471979856491089 (retained, as DOUBLE provides ˜15-16 decimal digits of precision)

### Custom Binary Storage

For the custom binary values:
−0.26 (example vector value)—Precision is 2 decimal places; scaled value is −0.26×10\hat{ }2=−26; storage is 1 byte (precision)+1 byte (scaled value)=2 bytes.
0.148578 (example vector value)—Precision is 6 decimal places; scaled value is 0.148578×10\hat{ }6=148578; storage is 1 byte (precision)+3 bytes (scaled value)=4 bytes.
0.36 (example vector value)—Precision is 2 decimal places; scaled value is 0.36×10\hat{ }2=36; storage is 1 byte (precision)+1 byte (scaled value)=2 bytes.

### Storage Requirements for Custom Binary Values:

−0.26 storage is 2 bytes;
0.148578 storage is 4 bytes;
0.36 storage is 2 bytes;
Total is 2+4+2=8 bytes.

Table II below provides summary of different storage types for vectors.

TABLE II

| | Storage Size | |
|---|---|---|
| Method | (Bytes) | Precision Retention |
| FLOAT | 4 bytes per value | Limited to ~7 decimal digits, |
| | | precision loss evident |
| DOUBLE | 8 bytes per value | Retains precision up to ~15-16 |
| | | decimal digits |
| Custom Binary | 2-4 bytes per | Retains exact precision with |
| (example) | value | variable storage size |

Accordingly, FLOAT is efficient in terms of storage size (e.g., four bytes per value) but suffers from precision loss for values requiring more than seven decimal digits. Additionally, DOUBLE retains precision (e.g., eight bytes per value) but uses more storage space. Meanwhile, custom binary as described herein balances storage efficiency and precision retention. Custom binary also uses variable storage size tailored to the precision of each value, which can be more storage-efficient while maintaining strict precision. Indeed, the custom binary solution is particularly advantageous for 1) datasets where precision varies significantly and needs to be maintained without unnecessary storage overhead 2) datasets that are portable (e.g., integrated into documents).

It is also practical to implement the technology described herein. For example, implementing the custom binary storage type via MySQL may be conducted as follows. MySQL does not support custom data types directly, but it is possible to store binary data using the BLOB or VARBINARY types.

Schema Design

```
<code below>
CREATE TABLE custom_binary_storage(
  id INT AUTO_INCREMENT PRIMARY KEY,
  binary_data LONGBLOB
);
```

PostgreSQL—PostgreSQL offers more flexibility with custom data types and extensions. The BYTEA type can be used to store binary data in this example.

Pinecone—Pinecone is a vector database specifically designed for handling vector embeddings. While this solution might not support custom binary types directly, storing encoded binary data is possible as metadata. Future vector databases, however, could integrate variable precision vectors as a native capability.

Accordingly, custom binary storage offers precision and storage efficiency benefits. Indeed, this capability may be integrated into most every type of database (e.g., vector included).

### Hardware Considerations

Fixed precision calculations are typically more efficient on GPUs. Variable precision calculations, however, could present an opportunity. In one example, a precision router can route calculations based on precision to an appropriate CPU, GPU, ASIC (application specific integrated circuit), accelerator, or FPGA (field-programmable gate array). Additionally, the vector database can be divided into shards based on precision.

### RAG Considerations

Variable precision vectors in RAG implementations address key problems of vector database size (e.g., inflation) applications begin to include many documents (e.g., both local and server based) that are vectorized to support chat processing needs of users.

Thus, the technology described herein provides dynamic precision adjustment (e.g., varying vector precision based on keyword importance identified via TF-IDF), keyword-based vector optimization (e.g., enhancing vector relevance by assigning higher precision to important terms), efficient vector storage (e.g., reducing database size by lowering precision for less significant words), integrated keyword identification (e.g., combining TF-IDF keyword extraction with variable precision vectorization), precision matching in retrieval (e.g., matching query precision to stored vector precision for improved similarity calculations) and/or portable and document embedded vectors.

FIG. 3 shows a method 30 of building a RAG vector database. The method 30 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 30 can be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 32 provides for identifying a first keyword and a second keyword in a plurality of keywords. In one example, the plurality of keywords correspond to a corpus of a RAG vector database. Block 34 determines that a first relevance associated with the first keyword is greater than a second relevance associated with the second keyword. Block 36 vectorizes the first keyword to a first level of precision and block 38 vectorizes the second keyword to a second level of precision. In the illustrated example, the first level of precision is greater than the second level of precision. Block 40 stores the vectorized first keyword and the vectorized second keyword in an RAG vector database. In an embodiment, block 40 also encodes the first level of precision with the vectorized first keyword in the RAG vector database and encodes the second level of precision with the vectorized second keyword in the RAG vector database. Block 42 may also embed the vectorized first keyword and the vectorized second keyword in a document.

The method 30 therefore enhances performance at least to the extent that varying the level of precision based on relevance during vectorization improves efficiency (e.g., reduced vector database size for faster retrieval), precision (e.g., higher precision assigned to important keywords, enhancing relevance), balance (e.g., optimized performance and accuracy by varying precision), storage (e.g., lower storage requirements through a reduction of precision in less important vectors), relevance (e.g., improved document retrieval relevance by emphasizing key terms), and/or portability (e.g., vectors can be embedded in documents and indexed by search engines, making it more practical for vector sets to become embedded in client-side documents).

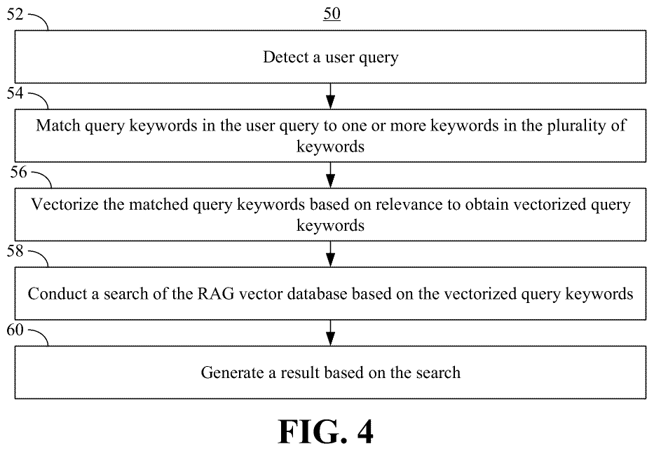

FIG. 4 shows a method 50 of handling user queries. The method 50 may generally be implemented in conjunction with the method 30 (FIG. 3), already discussed. More particularly, the method 50 may be implemented in one or more modules as a set of logic instructions stored in a machine- or computer-readable storage medium such as RAM, ROM, ROM), firmware, flash memory, etc., in hardware, or any combination thereof.

Illustrated processing block 52 provides for detecting a user query, wherein block 54 matches query keywords in the user query to one or more keywords in the plurality of keywords. Additionally, block 56 vectorizes the matched query keywords based on relevance to obtain vectorized query keywords. Block 58 may conduct a search of the RAG vector database based on the vectorized query keywords, wherein block 60 generates a result based on the search.

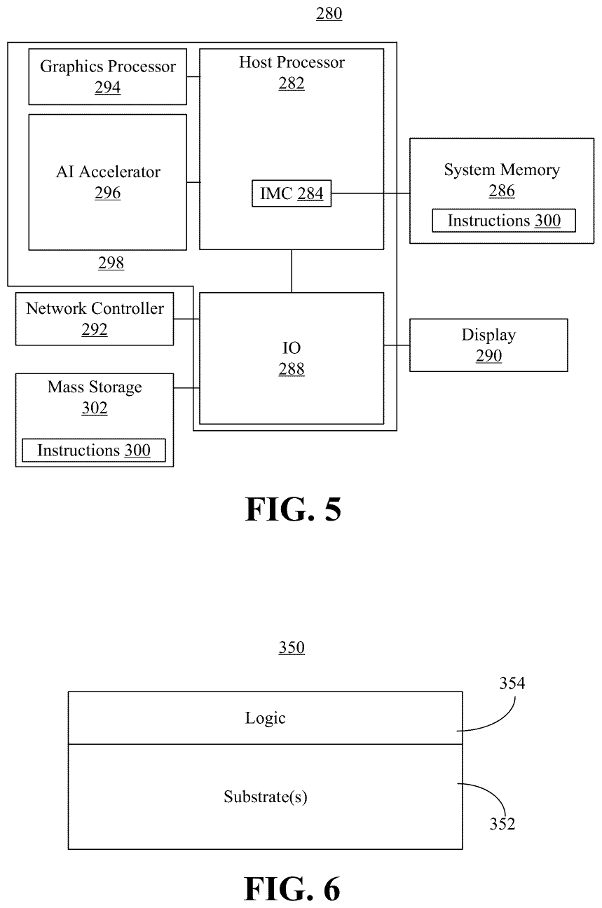

Turning now to FIG. 5, a performance-enhanced computing system 280 is shown. The system 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, drone functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM including dynamic RAM/DRAM). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an AI accelerator 296 (e.g., specialized processor) into a system on chip (SoC) 298.

In an embodiment, the AI accelerator 296 and/or the host processor 282 execute instructions 300 retrieved from the system memory 286 and/or the mass storage 302 to perform one or more aspects of the method 30 (FIG. 3) and/or the method 50 (FIG. 3), already discussed. Thus, execution of the instructions 300 causes the AI accelerator 296, the host processor 282 and/or the computing system 280 to identify a first keyword and a second keyword in a plurality of keywords, determine that a first relevance associated with the first keyword is greater than a second relevance associated with the second keyword, vectorize the first keyword to a first level of precision, vectorize the second keyword to a second level of precision, wherein the first level of precision is greater than the second level of precision, and store the vectorized first keyword and the vectorized second keyword in an RAG vector database.

The computing system 280 is therefore considered to be performance-enhanced at least to the extent that varying the level of precision based on relevance during vectorization improves efficiency (e.g., reduced vector database size for faster retrieval), precision (e.g., higher precision assigned to important keywords, enhancing relevance), balance (e.g., optimized performance and accuracy by varying precision), storage (e.g., lower storage requirements through a reduction of precision in less important vectors), relevance (e.g., improved document retrieval relevance by emphasizing key terms), and/or portability (e.g., vectors can be embedded in documents and indexed by search engines, making it more practical for vector sets to become embedded in client-side documents).

FIG. 6 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 30 (FIG. 3) and/or the method 50 (FIG. 3), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

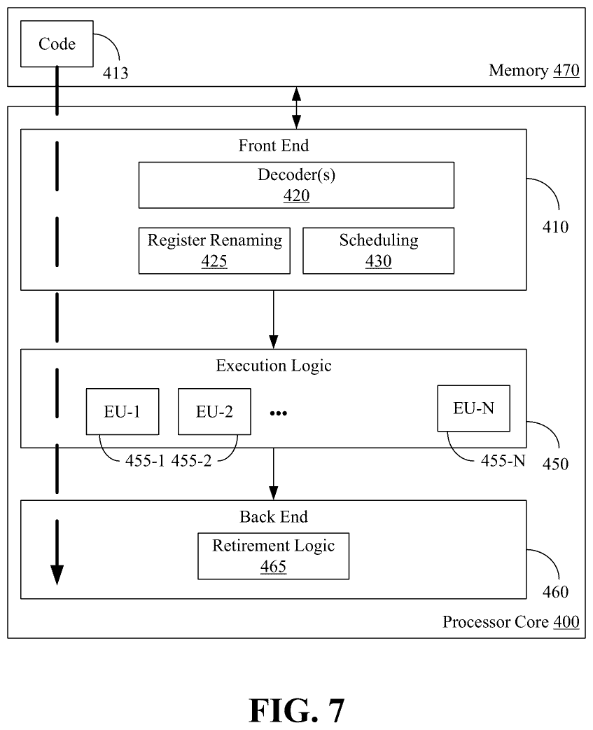

FIG. 7 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 7, a processing element may alternatively include more than one of the processor core 400 illustrated in FIG. 7. The processor core 400 may be a single-threaded core or, for at least one embodiment, the processor core 400 may be multithreaded in that it may include more than one hardware thread context (or “logical processor”) per core.

FIG. 7 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 30 (FIG. 3) and/or the method 50 (FIG. 3), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 7, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

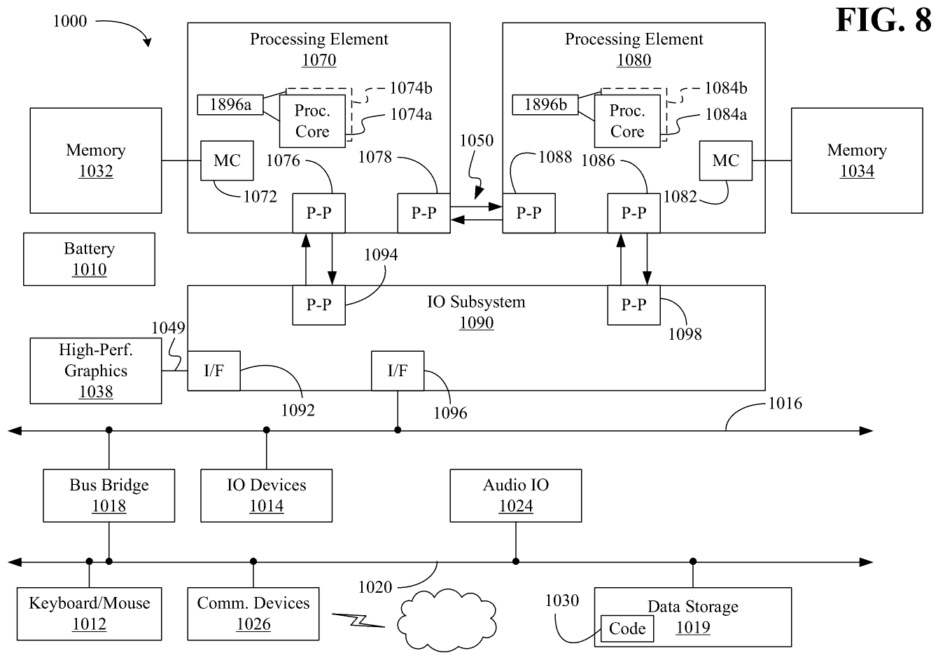

Referring now to FIG. 8, shown is a block diagram of a computing system 1000 embodiment in accordance with an embodiment. Shown in FIG. 8 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 8 may be implemented as a multi-drop bus rather than point-to-point interconnect.

As shown in FIG. 8, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 7.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 8, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 8, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 8, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 30 (FIG. 3) and/or the method 50 (FIG. 3), already discussed. Further, an audio I/O 1024 may be coupled to second bus 1020 and a battery 1010 may supply power to the computing system 1000.

Note that other embodiments are contemplated. For example, instead of the point-to-point architecture of FIG. 8, a system may implement a multi-drop bus or another such communication topology. Also, the elements of FIG. 8 may alternatively be partitioned using more or fewer integrated chips than shown in FIG. 8.

Variable precision in vectorization as described herein may be implemented in INTEL AI PCs, which use artificial intelligence technologies to elevate productivity, creativity, gaming, entertainment, security, and more. INTEL AI PCs have a CPU, GPU, and NPU (neural processing unit) to handle AI tasks locally and more efficiently.

### Additional Notes and Examples

Example 1 includes a performance-enhanced computing system comprising a network controller, a processor, and a memory coupled to the processor, wherein the memory includes a plurality of executable program instructions, which when executed by the processor, cause the processor to identify a first keyword and a second keyword in a plurality of keywords, determine that a first relevance associated with the first keyword is greater than a second relevance associated with the second keyword, vectorize the first keyword to a first level of precision, vectorize the second keyword to a second level of precision, wherein the first level of precision is greater than the second level of precision, and store the vectorized first keyword and the vectorized second keyword to a retrieval-augmented generation (RAG) vector database.

Example 2 includes the computing system of Example 1, wherein the executable program instructions, when executed, further cause the processor to embed the vectorized first keyword and the vectorized second keyword in a document.

Example 3 includes the computing system of Example 1, wherein the instructions, when executed, further cause the processor to encode the first level of precision with the vectorized first keyword in the RAG vector database, and encode the second level of precision with the vectorized second keyword in the RAG vector database.

Example 4 includes the computing system of Example 1, wherein the plurality of keywords are to correspond to a corpus of the RAG vector database.

Example 5 includes the computing system of any one of Examples 1 to 4, wherein the executable program instructions, when executed, further cause the processor to detect a user query, match query keywords in the user query to one or more keywords in the plurality of keywords, vectorize the matched query keywords based on relevance to obtain vectorized query keywords, conduct a search of the RAG vector database based on the vectorized query keywords, and generate a result based on the search.

Example 6 includes at least one computer readable storage medium comprising a set of executable program instructions which, when executed by a computing system, cause the computing system to identify a first keyword and a second keyword in a plurality of keywords, determine that a first relevance associated with the first keyword is greater than a second relevance associated with the second keyword, vectorize the first keyword to a first level of precision, vectorize the second keyword to a second level of precision, wherein the first level of precision is greater than the second level of precision, and store the vectorized first keyword and the vectorized second keyword to a retrieval-augmented generation (RAG) vector database.

Example 7 includes the at least one computer readable storage medium of Example 6, wherein the executable program instructions, when executed, further cause the computing system to embed the vectorized first keyword and the vectorized second keyword in a document.

Example 8 includes the at least one computer readable storage medium of Example 6, wherein the instructions, when executed, further cause the computing system to encode the first level of precision with the vectorized first keyword in the RAG vector database, and encode the second level of precision with the vectorized second keyword in the RAG vector database.

Example 9 includes the at least one computer readable storage medium of Example 6, wherein the plurality of keywords are to correspond to a corpus of the RAG vector database.

Example 10 includes the at least one computer readable storage medium of any one of Examples 6 to 9, wherein the executable program instructions, when executed, further cause the computing system to detect a user query, match query keywords in the user query to one or more keywords in the plurality of keywords, and vectorize the matched query keywords based on relevance to obtain vectorized query keywords.

Example 11 includes the at least one computer readable storage medium of Example 10, wherein the executable program instructions, when executed, further cause the computing system to conduct a search of the RAG vector database based on the vectorized query keywords.

Example 12 includes the at least one computer readable storage medium of Example 11, wherein the executable program instructions, when executed, further cause the computing system to generate a result based on the search.

Example 13 includes a semiconductor apparatus comprising one or more substrates, and logic coupled to the one or more substrates, wherein the logic is implemented at least partly in one or more of configurable or fixed-functionality hardware, the logic to identify a first keyword and a second keyword in a plurality of keywords, determine that a first relevance associated with the first keyword is greater than a second relevance associated with the second keyword, vectorize the first keyword to a first level of precision, vectorize the second keyword to a second level of precision, wherein the first level of precision is greater than the second level of precision, and store the vectorized first keyword and the vectorized second keyword to a retrieval-augmented generation (RAG) vector database.

Example 14 includes the semiconductor apparatus of Example 13, wherein the logic is to embed the vectorized first keyword and the vectorized second keyword in a document.

Example 15 includes the semiconductor apparatus of Example 13, wherein the logic is further to encode the first level of precision with the vectorized first keyword in the RAG vector database, and encode the second level of precision with the vectorized second keyword in the RAG vector database.

Example 16 includes the semiconductor apparatus of Example 13, wherein the plurality of keywords are to correspond to a corpus of the RAG vector database.

Example 17 includes the semiconductor apparatus of any one of Examples 13 to 16, wherein the logic is further to detect a user query, match query keywords in the user query to one or more keywords in the plurality of keywords, and vectorize the matched query keywords based on relevance to obtain vectorized query keywords.

Example 18 includes the semiconductor apparatus of Example 17, wherein the logic is further to conduct a search of the RAG vector database based on the vectorized query keywords.

Example 19 includes the semiconductor apparatus of Example 18, wherein the logic is further to generate a result based on the search.

Example 20 includes the semiconductor apparatus of any one of Examples 13 to 19, wherein the logic coupled to the one or more substrates includes transistor regions that are positioned within the one or more substrates.

Example 21 includes a method of operating a performance-enhanced computing system, the method comprising identifying a first keyword and a second keyword in a plurality of keywords, determining that a first relevance associated with the first keyword is greater than a second relevance associated with the second keyword, vectorizing the first keyword to a first level of precision, vectorizing the second keyword to a second level of precision, wherein the first level of precision is greater than the second level of precision, and storing the vectorized first keyword and the vectorized second keyword to a retrieval-augmented generation (RAG) vector database.

Example 22 includes an apparatus comprising means for performing the method of Example 21.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller;
a processor coupled to the network controller; and
a memory coupled to the processor, the memory including a set of executable program instructions which, when executed by the processor, cause the processor to:
identify a first keyword and a second keyword in a plurality of keywords,
determine that a first relevance associated with the first keyword is greater than a second relevance associated with the second keyword,
vectorize the first keyword to a first level of precision,
vectorize the second keyword to a second level of precision, wherein the first level of precision is greater than the second level of precision, and
store the vectorized first keyword and the vectorized second keyword to a retrieval-augmented generation (RAG) vector database.

2. The computing system of claim 1, wherein the executable program instructions, when executed, further cause the processor to embed the vectorized first keyword and the vectorized second keyword in a document.

3. The computing system of claim 1, wherein the instructions, when executed, further cause the processor to:
encode the first level of precision with the vectorized first keyword in the RAG vector database, and
encode the second level of precision with the vectorized second keyword in the RAG vector database.

4. The computing system of claim 1, wherein the plurality of keywords are to correspond to a corpus of the RAG vector database.

5. The computing system of claim 1, wherein the executable program instructions, when executed, further cause the processor to:
detect a user query;
match query keywords in the user query to one or more keywords in the plurality of keywords;
vectorize the matched query keywords based on relevance to obtain vectorized query keywords;
conduct a search of the RAG vector database based on the vectorized query keywords; and
generate a result based on the search.

6. At least one computer readable storage medium comprising a set of executable program instructions which, when executed by a computing system, cause the computing system to:
identify a first keyword and a second keyword in a plurality of keywords;
determine that a first relevance associated with the first keyword is greater than a second relevance associated with the second keyword;
vectorize the first keyword to a first level of precision;
vectorize the second keyword to a second level of precision, wherein the first level of precision is greater than the second level of precision; and
store the vectorized first keyword and the vectorized second keyword to a retrieval-augmented generation (RAG) vector database.

7. The at least one computer readable storage medium of claim 6, wherein the executable program instructions, when executed, further cause the computing system to embed the vectorized first keyword and the vectorized second keyword in a document.

8. The at least one computer readable storage medium of claim 6, wherein the instructions, when executed, further cause the computing system to:
encode the first level of precision with the vectorized first keyword in the RAG vector database; and
encode the second level of precision with the vectorized second keyword in the RAG vector database.

9. The at least one computer readable storage medium of claim 6, wherein the plurality of keywords are to correspond to a corpus of the RAG vector database.

10. The at least one computer readable storage medium of claim 6, wherein the executable program instructions, when executed, further cause the computing system to:
detect a user query;
match query keywords in the user query to one or more keywords in the plurality of keywords; and
vectorize the matched query keywords based on relevance to obtain vectorized query keywords.

11. The at least one computer readable storage medium of claim 10, wherein the executable program instructions, when executed, further cause the computing system to conduct a search of the RAG vector database based on the vectorized query keywords.

12. The at least one computer readable storage medium of claim 11, wherein the executable program instructions, when executed, further cause the computing system to generate a result based on the search.

13. A semiconductor apparatus comprising:
one or more substrates; and
logic coupled to the one or more substrates, wherein the logic is implemented at least partly in one or more of configurable or fixed-functionality hardware, the logic to:
identify a first keyword and a second keyword in a plurality of keywords;
determine that a first relevance associated with the first keyword is greater than a second relevance associated with the second keyword;
vectorize the first keyword to a first level of precision;
vectorize the second keyword to a second level of precision, wherein the first level of precision is greater than the second level of precision; and
store the vectorized first keyword and the vectorized second keyword to a retrieval-augmented generation (RAG) vector database.

14. The semiconductor apparatus of claim 13, wherein the logic is to embed the vectorized first keyword and the vectorized second keyword in a document.

15. The semiconductor apparatus of claim 13, wherein the logic is further to:
encode the first level of precision with the vectorized first keyword in the RAG vector database; and
encode the second level of precision with the vectorized second keyword in the RAG vector database.

16. The semiconductor apparatus of claim 13, wherein the plurality of keywords are to correspond to a corpus of the RAG vector database.

17. The semiconductor apparatus of claim 13, wherein the logic is further to:
detect a user query;
match query keywords in the user query to one or more keywords in the plurality of keywords; and
vectorize the matched query keywords based on relevance to obtain vectorized query keywords.

18. The semiconductor apparatus of claim 17, wherein the logic is further to conduct a search of the RAG vector database based on the vectorized query keywords.

19. The semiconductor apparatus of claim 18, wherein the logic is further to generate a result based on the search.

20. The semiconductor apparatus of claim 13, wherein the logic coupled to the one or more substrates includes transistor regions that are positioned within the one or more substrates.
